(19) United States
(12) Patent Application Publication
(10) Pub. No.: US 2019/0146499 A1
(43) Pub. Date: May 16, 2019

(54) Transportation Method and Transportation System for Controlling an Automated Guided Vehicle

(71) Applicant: QISDA CORPORATION, Taoyuan City (TW)

(72) Inventors: Chiung-Chi Wang, Taoyuan City (TW); Chen-Feng Huang, Taoyuan City (TW); Hung-Chih Chan, Taoyuan City (TW)

(21) Appl. No.: 16/116,929

(22) Filed: Aug. 30, 2018

(30) Foreign Application Priority Data
Nov. 15, 2017 (CN) 201711131837.X

(51) Int. Cl. G05D 1/00; G05D 1/02

(52) U.S. Cl. CPC G05D 1/0088; G05D 2201/0212; G05D 1/0212

(57) ABSTRACT

A transportation method includes sensing an identification device by a sensor for generating a sensing signal, transmitting the sensing signal to a server, identifying personal information corresponding to the sensing signal by the server according to the sensing signal, generating path scheduling data by the server through a database according to the personal information, and controlling the automated guided vehicle by the server to travel to a first designated location indicated by the path scheduling data.

### BACKGROUND OF THE INVENTION

### 1. Field of the Invention

The present invention illustrates a transportation method and a transportation system, and more particularly, a transportation method and a transportation system for controlling an automated guided vehicle.

### 2. Description of the Prior Art

With rapid advancement of sciences and technologies, various automated transportation tools have become popular. Many manufacturers use automated guided vehicles (AGVs) to assist in transportation of materials or personnel for improving security and saving manpower. Automated guided vehicles are commonly used in a warehouse, a manufacturing place, post offices, libraries, port terminals, airports, or some hazardous locations and specialty industries. Compared with other equipment commonly used in transporting materials, the automated guided vehicles have advantages of preforming a quick action, high work efficiency, simple structure, strong controllability, and satisfactory security. Active areas (or say, travelling areas) of the automatic guided vehicles may not be bounded with fixed rails, brackets, etc. Therefore, the automated guided vehicles can travel in various environments. When the automated guided vehicles are applied to a logistics system, an automation and efficiency of transporting productions can be greatly increased. By using the automated guided vehicles, a driverless or say, a self-driving technology and flexible transportation mechanisms can be realized.

A conventional automated guided vehicle has an automatic guiding device such as an electromagnetic or an optical device so that it can travel along a predetermined guided route. The automated guided vehicle can use rechargeable batteries as a power source. Generally, a guided route or motion of the automated guided vehicle can be self-controlled by its own computer, or controlled by an electromagnetic path-following system affixed on the floor. Therefore, the risk of working in a dangerous environment can be reduced since a transportation person can be replaced with the automated guided vehicle. For example, the automated guided vehicle can be used in a radiation environment in order to prevent personnel from exposing to radiation. Further, the automated guided vehicle can also accurately and reliably transport materials and products in a dark environment.

However, the conventional automated guided vehicle cannot be dispatched in real time by using a control center through a cloud network. In other words, the conventional automated guided vehicle uses its predetermined route data stored in a memory of its computer for transporting products or persons. Therefore, the conventional automated guided vehicle cannot be applied to an environment with respect to a medical system, which changes rapidly over time (i.e., such as a hospital). In other words, the conventional automated guided vehicle lacks capabilities of real time dispatching and scheduling by the control center. If the conventional automated guided vehicle is applied to the medical system, it results in poor efficiency of a medical process and confusion in a route of medical consultation.

### SUMMARY OF THE INVENTION

In an embodiment of the present invention, a transportation method for controlling an automated guided vehicle is disclosed. The transportation method comprises sensing an identification device by a sensor for generating a sensing signal, transmitting the sensing signal to a server, identifying personal information corresponding to the sensing signal by the server according to the sensing signal, generating path scheduling data by the server through a database according to the personal information, and controlling the automated guided vehicle by the server to travel to a first designated location indicated by the path scheduling data.

In an embodiment of the present invention, a transportation system is disclosed. The transportation system comprises an automated guided vehicle, a server, and a sensor. The automated guided vehicle is configured to provide a transportation service of taking a passenger. The server is linked to the automated guided vehicle and configured to control the automated guided vehicle. The sensor is linked to the server and configured to sense an identification device for verifying personal information of the passenger. The sensor generates a sensing signal by sensing the identification device and transmits the sensing signal to the server. The server identifies the personal information according to the sensing signal, generates path scheduling data through a database of the server according the personal information, and controls the automated guided vehicle to travel to a first designated location indicated by the path scheduling data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a transportation system according to an embodiment of the present invention.

FIG. 2 is a block diagram of a server of the transportation system in FIG. 1.

FIG. 3 is an illustration of communications among an identification device, a sensor, components inside an automated guided vehicle, and the server of the transportation system in FIG. 1.

FIG. 4 is a flow chart of a transportation method by using the transportation system in FIG. 1.

### DETAILED DESCRIPTION

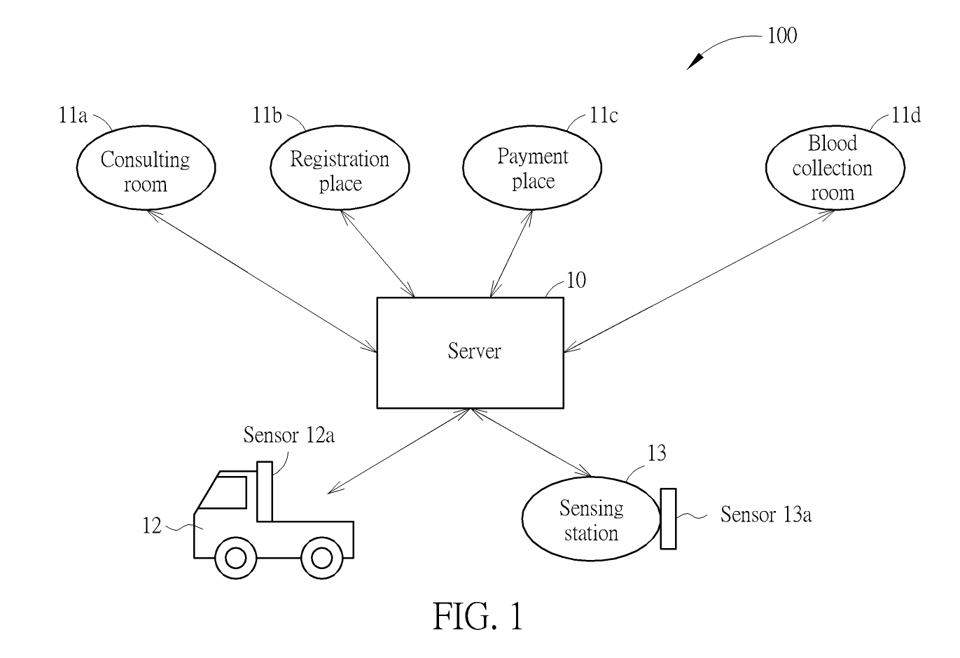

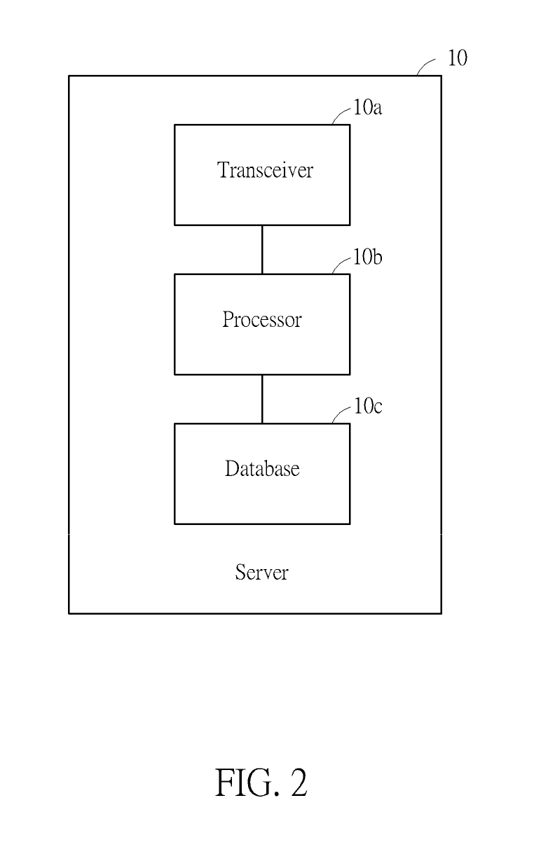

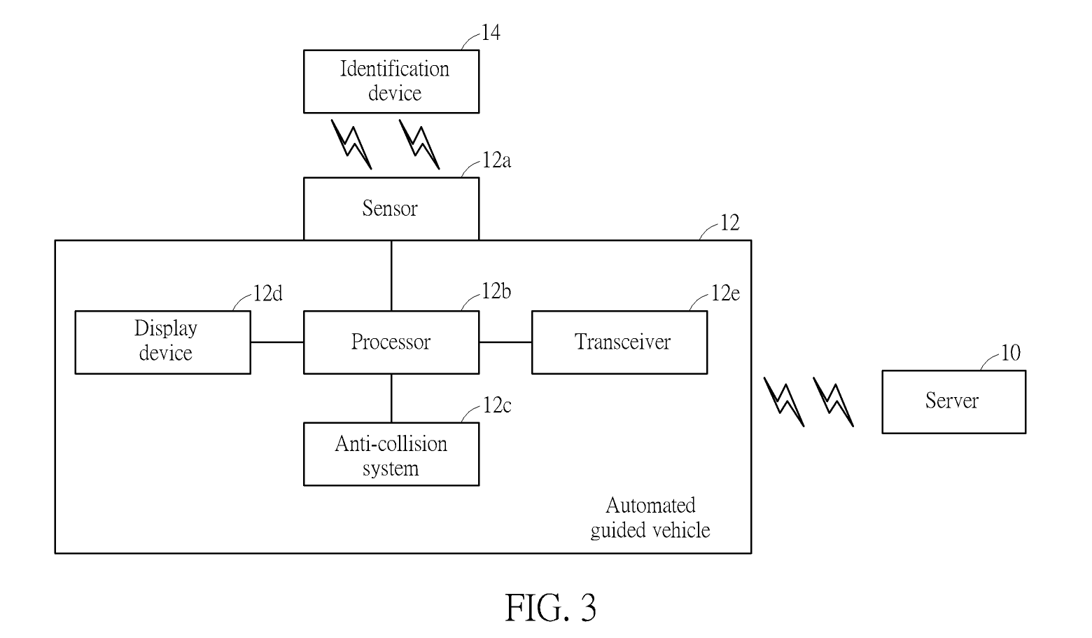

FIG. 1 is a block diagram of a transportation system 100 according to an embodiment of the present invention. The transportation system 100 can be used in any place. For simplicity, the transportation system 100 for a medical system (i.e., a hospital place) is described below. Any reasonable application of the transportation system 100 falls into the scope of the present invention. The transportation system 100 includes an automated guided vehicle 12, a server 10, and a sensor 12a. The automated guided vehicle 12 can be any autopilot carrier, which can be moved by using any rolling device such as wheels or caterpillar bands. The automated guided vehicle 12 is capable of carrying heavy objects. Thus, the automated guided vehicle 12 can provide a transportation service of taking a passenger. The server 10 is linked to the automated guided vehicle 12 for controlling the automated guided vehicle 12. The server 10 can be any type of a control station, such as a cloud control server, a central control device, a terminal control center, or a big data exchange center. The server 10 can perform bi-directional communications with the automated guided vehicle 12. Further, the server 10 can also be linked to a plurality of medical stations in order to obtain statuses of these medical stations. For example, the server 10 can be linked to machine stations such as a consulting room 11a, a registration place 11b, a payment place 11c, and a blood collection room 11d so as to acquire status data of these machine stations. The sensor 12a is linked to the server 10 for sensing an identification device 14 (as shown in FIG. 3) for verifying personal information of the passenger. The sensor 12a can be disposed on the automated guided vehicle 12. The identification device 14 can be an identification card, such as a health insurance card, a medical insurance card, a smart card, or a barcode identification card. Any device with personal fingerprint data or face recognition data can also be regarded as the identification device 14. The sensor 12a can be a chip-card reader, a near-field communication (NFC) wireless sensor, a radio frequency identification (RFID) sensor, or an infrared scanner. In the transportation system 100, the sensor 12a can generate a sensing signal by sensing the identification device 14 and then transmit the sensing signal to the server 10. After the server 10 receives the sensing signal, the server 10 can identify the personal information according to the sensing signal. Then, the server 10 can generate path scheduling data through a database 10c (as shown in FIG. 2) according the personal information. Then, the server 10 can control the automated guided vehicle 12 to travel to a first designated location indicated by the path scheduling data. The transportation method is illustrated later.

The transportation system 100 can further include a sensing station 13. A location of the sensing station 13 is not limited to FIG. 1. The sensing station 13 can be disposed on any fixed or predetermined location, such as a hospital entrance gate or a hospital counter. The sensing station 13 can be disposed around the passenger. The sensor can be disposed on the sensing station 13. For avoiding ambiguity, the sensor disposed on the sensing station 13 is denoted as “the sensor 13a” hereafter. Particularly, the sensor 13a and the sensor 12a have similar functions and both have capabilities of sensing the identification device 14 for generating the sensing signal to the server 10. Therefore, identification technology and communications of the sensor 13a are omitted here. In the following, a transportation method by using the transportation system 100 is illustrated for an application of medical consulting process in conjunction with a structure of the server 10 in FIG. 2.

FIG. 2 is a block diagram of the server 10 of the transportation system 100. In the embodiment, a passenger is defined as a user who carries the identification device 14, such as the health insurance card. When the passenger goes to the hospital and begins a procedure of medical consultation, the passenger can go to the sensing station 13 and approach the identification device 14 to the sensing device 13a for generating the sensing signal. Alternatively, the passenger can directly take a ride on the automated guided vehicle 12 with an available status and then approach the identification device 14 to the sensing device 12a for generating the sensing signal. Here, the automated guided vehicle 12 can use a lighting change or a sound frequency change for notifying the passenger in order to recognize whether the automated guided vehicle 12 is operated under the available status or an occupied status. Ina first operation process, after the passenger approaches the identification device 14 to the sensing device 13a for generating the sensing signal, the sensing signal is transmitted to a transceiver 10a of the server 10. Then, the transceiver 10a can demodulate or decode the sensing signal by using the processor 10b for recognizing the passenger's personal information. Since the passenger's personal information can be identified by the server 10, the server 10 can acquire information of hospital visiting records (history or log files) of the passenger, a medical consultation procedure of the passenger, and habits of the passenger according to the personal information through the database 10c. Accordingly, the server 10 can generate path scheduling data. For example, the server 10 can generate path scheduling data indicating the route: the registration place 11b→the consulting room 11a→the blood collection room 11d→returning to the consulting room 11a→the payment place 11c. Therefore, the path scheduling data generated by the server 10 can indicate a plurality of locations. Then, the server 10 can control the automated guided vehicle 12 to pick up the passenger. The passenger can show the identification device 14 again to confirm his/her identity by the sensing device 12a. Then, the automated guided vehicle 12 can carry the passenger to travel to a first designated location indicated by the path scheduling data, such as the registration place 11b. As previously mentioned, an initial mode of the automated guided vehicle 12 can be the available mode. After the automated guided vehicle 12 receives a dispatch signal from the transceiver 10a of the server 10, a status of the automated guided vehicle 12 can be changed from the available mode to an occupied mode. Therefore, when the automated guided vehicle 12 is operated under the occupied mode, the transportation service for another passenger of the automated guided vehicle 12 is unavailable.

In a second operation process, the passenger can directly take a ride on an automated guided vehicle 12 with the available status and then approach the identification device 14 to the sensing device 12a for generating the sensing signal. Similarly, the sensing signal is transmitted to the transceiver 10a of the server 10. Then, the transceiver 10a can demodulate or decode the sensing signal by using the processor 10b for recognizing the passenger's personal information. Since the passenger's personal information of hospital visiting records (history or log files) of the passenger, a medical consultation procedure of the passenger, and habits of the passenger according to the personal information through the database 10c can be acquired, accordingly, the server 10 can generate path scheduling data. Then, the automated guided vehicle 12 can carry the passenger to travel to the first designated location indicated by the path scheduling data, such as the registration place 11b. Further, the server 10 can dynamically adjust the path scheduling data according to the passenger's personal information and requirement of the passenger. For example, a passenger requiring a follow-up consultation process can directly travel to the clinic before completing a register process, as long as the identification device 14 is detected by the sensor 12a or 13a. Then, the server 10 can reschedule an initial travelling route by eliminating/adding some locations. For example, as previously mentioned, the server 10 can initially generate the path scheduling data indicating the route: the registration place 11b→the consulting room 11a→the blood collection room 11d→returning to the consulting room 11a→the payment place 11c. However, for the passenger requiring the follow-up consultation process, the server 10 can reschedule the travelling route. For example, the server 10 can eliminate the registration place 11b for updating the path scheduling data to be: the consulting room 11a→the blood collection room 11d→returning to the consulting room 11a→the payment place 11c. Further, the initial operation mode of the automated guided vehicle 12 can be the available mode. After the automated guided vehicle 12 starts to provide a transportation service of taking the passenger, the status of the automated guided vehicle 12 can be changed from the available mode to an occupied mode. Therefore, when the automated guided vehicle 12 is operated under the occupied mode, the transportation service for another passenger of the automated guided vehicle 12 is unavailable.

Since the transportation system 100 can be applied to the hospital, the transportation system 100 can optimize the path scheduling data for improving travelling efficiency. In FIG. 1, the transceiver 10a of the server 10 can be linked to machine stations such as a consulting room 11a, a registration place 11b, a payment place 11c, and a blood collection room 11d so as to acquire status data of these machine stations. In other words, the server 10 can acquire status data of these locations by receiving feedback signals generated from corresponding machine stations. The “status data” can include queuing status data, emergency status data, and data of current identification tag of queue. In other words, the server 10 can receive status data of a plurality of locations indicated by the path scheduling data after the path scheduling data is generated by the server 10. Then, the server 10 can generate a first sequence according to the status data of the plurality of locations. For example, if a passenger needs to enter an X-ray room, an electrocardiogram room, a blood collection room, and an ultrasound room, the server 10 can optimize a sequence of travelling to these locations according to data of current identification tags of queues. By optimizing the sequence of locations, additional time consumption of the passenger can be reduced. Further, the status data of the plurality of locations can include instantaneous transportation data of the locations received by the server 10 in real time or statistic transportation data of the locations stored in the database 10c. The server 10 can control the automated guided vehicle 12 to provide a service for taking the passenger to a first designated location with a priority higher than other locations indicated by the path scheduling data. By doing so, the travelling efficiency can be increased. Further, when the identification device 14 is detected by the sensing device 12a or 13a, its utilization state can be regarded as a check-in state. Thus, even if a transportation time is introduced, the user's registration time is not delayed.

In the embodiment, the consulting room 11a is an essential location of the path scheduling data. The passenger must come to the consulting room 11a to get a doctor's professional medical advice. Therefore, the server 10 can dynamically adjust, change, or update the path scheduling data according to the doctor's professional medical advice. For example, the server 10 linked to the machine station of the consulting room 11a receives the doctor's medical advice that the passenger (patient) must immediately take an X-ray inspection process. Then, the machine station of the consulting room 11a can generate a command signal to the server 10. After the server 10 receives the command signal, the server 10 can update the path scheduling data immediately by inserting the X-ray room as a next location. Further, the server 10 can generate a control signal according to the command signal. Then, the automated guided vehicle 12 can travel to a location (i.e., the X-ray room) corresponding to the command signal according to the control signal. Also, the server 10 can flexibly change the sequence of a plurality of locations (i.e., multi-consultations for the passenger) according to an instruction of the doctor or an instantaneous control of the passenger. Therefore, the transportation system 100 can provide high maneuverability.

The transportation system 100 can also have a scheduling insertion function. The passenger can manually insert at least one location to the path scheduling data. For example, the passenger can insert at least one location through an interactive device (i.e., a screen or a keyboard) of the automated guided vehicle 12. Then, the automated guided vehicle 12 can generate an insertion signal to the server 10. After the transceiver 10a of the server 10 receives the insertion signal, the server 10 can acquire status data of a plurality of locations indicated by the path scheduling data and the insertion signal. For example, in the database 10c of the server 10, the path scheduling data corresponding to the personal information initially indicates five locations. After the passenger manually inserts three locations to the path scheduling data, the processor 10b of the server 10 receives status data of eight locations through the transceiver 10a and then optimizes a sequence of travelling to these eight locations. In other words, the server 10 can generate a second sequence according to the status data of the plurality of locations. Further, since at least one location (i.e., data of at least one location) is added to the original path scheduling data, the server 10 can update the path scheduling data in order to generate updated path scheduling data. Then, the server 10 can control the automated guided vehicle 12 to travel to a second designated location indicated by the updated path scheduling data. Similarly, the status data of the plurality of locations can include instantaneous transportation data of the locations received by the server 10 in real time or statistic transportation data of the locations stored in the database 10c. The updated path scheduling data indicates the plurality of locations of the path scheduling data and the insertion signal. The server 10 can control the automated guided vehicle 12 to provide a service for taking the passenger to a second designated location with a priority higher than other locations indicated by the updated path scheduling data. By doing so, the travelling efficiency can be increased.

In order to further improve the travelling efficiency of the transportation system 100, a timer can be introduced to the automated guided vehicle 12. As previously mentioned, the initial operation mode of the automated guided vehicle 12 can be the available mode. After the automated guided vehicle 12 is controlled by the server 10, a status of the automated guided vehicle 12 can be changed from the available mode to the occupied mode. However, after the automated guided vehicle 10 reaches a passenger's location or the first designated location indicated by the path scheduling data, the automated guided vehicle 12 can still be operated under the occupied mode and start to enable the timer. A purpose of introducing the timer is that the transportation system 100 can avoid wasting a lot of transportation resources by limiting an idle time of the automated guided vehicle 12. When an activated time of the timer reaches a predetermined idle time, the automated guided vehicle 12 can change a status from the occupied mode to the available mode. The timer is activated as long as the automated guided vehicle 12 is parked at the first designated location. By doing so, the automated guided vehicle 12 can be used for another passengers in order to optimize the transportation resources by avoiding additional idle time. Further, to enhance flexibility of the transportation, the transportation system 100 can introduce a waiting time. For example, after the automated guided vehicle 12 takes the passenger to the first designated location indicated by the path scheduling data, the passenger can reasonably set a waiting time. For example, after the automated guided vehicle 12 takes the passenger to reach the blood collection room 11d, the passenger can set a waiting time equal to 3 minutes. Particularly, the waiting time can be slightly longer than the idle time. The automated guided vehicle 12 is operated under the occupied mode during the waiting time. In other words, if the passenger completes the current medical action (such as a blood collection) within the waiting time, the passenger can still continue to the next location by using the automated guided vehicle 12 previously used.

The transportation system 100 also has a scheduling interruption function to cope with various emergency situations. For example, when the automated guided vehicle 12 is on its way to carry the passenger to the first designated location, once the passenger suddenly feels unwell or suddenly has an emergency event (for example, the passenger wants to go to a bathroom or a telephone station), the passenger can interrupt a current task of the automated guided vehicle 12. For example, the passenger can input an interruption signal to the automated guided vehicle 12 by using an interactive device such as a keyboard or a touch screen. After the automated guided vehicle 12 receives the interruption signal, the automated guided vehicle 12 can change a status from the occupied mode to the available mode. Then, the automated guided vehicle 12 can transmit a status change message to the server 10 and stop the current service of carrying the passenger. Since the automated guided vehicle 12 is operated under the available mode, the transportation service for another passenger of the automated guided vehicle 12 is available. Further, the passenger who interrupts a current transportation service can also get off the automated guided vehicle 12 at any time to handle an incident. Therefore, the transportation system 100 has high operational flexibility.

FIG. 3 is an illustration of communications among the identification device 14, the sensor 12a, components inside the automated guided vehicle 12, and the server 10 of the transportation system 100. The automated guided vehicle 12 includes a transceiver 12e, a processor 12b, an anti-collision system 12c, and a display device 12d. The transceiver 12e is used for receiving a control signal generated by the server 10 and transmitting the sensing signal to the server 10. As previously mentioned, the sensor 12a can generate the sensing signal by sensing the identification device 14. The sensor 12a can be coupled to the processor 12b for generating the sensing signal to the server 10 through the transceiver 12e. The transceiver 12e can also be used for transmitting the insertion signal and interruption signal to the server 10. The processor 12b is coupled to the sensor 12a and the transceiver 12e for processing the sensing signal (i.e., performing a modulation process and an encryption process) and controlling a travelling route of the automated guided vehicle 12 according to the control signal. Further, the automated guided vehicle 12 also includes an interactive device such as a display device 12d in FIG. 3, a touch screen, a keyboard, a mouse, or any other data input/output (I/O) device. For example, the display device 12d can provide a touch function and can be coupled to the processor 12b. Therefore, the waiting time, the insertion location, the interruption command (signal) can be inputted to the automated guided vehicle 12 through the display device 12d. Further, a timer function can be introduced to the processor 12b of the automated guided vehicle 12. The timer function of the automated guided vehicle 12 can be executed after the automated guided vehicle 12 reaches the first designated location. A status of the automated guided vehicle 12 is changed from the occupied mode to the available mode when an activated time of the timer function reaches to a predetermined idle time and the timer is activated as long as the automated guided vehicle 12 is parked at the first designated location. The processor 12b can be synchronized with the server 10 through the transceiver 12e. Further, the automated guided vehicle 12 can include an anti-collision system 12c coupled to the processor 12b for avoiding an obstacle around the automated guided vehicle 12. Thus, a risk of collision can be reduced when the automated guided vehicle 12 is travelling. The automated guided vehicle 12 can also introduce a speaker and an indicator lamp for notifying the passengers a current status of the automated guided vehicle 12. Any reasonable hardware modification of the automated guided vehicle 12 falls into the scope of the present invention. In FIG. 3, all components of the automated guided vehicle 12 and the server 10 are synchronized through the transceiver 12e. Therefore, the server 10 can synchronously acquire information of a current location, a speed, a passenger's situation, a task status, and a battery power level of the automated guided vehicle 12. When a plurality of automated guided vehicles 12 are dispatched to provide service of taking passengers to different locations, the server 10 can keep track of statuses of all automated guided vehicles 12 at any time for optimizing overall travelling efficiency of passengers. For example, since the server 10 can acquire locations of all automated guided vehicles 12, it can dispatch an available automated guided vehicle 12 closest to the passenger to pick up the passenger for improving travelling efficiency.

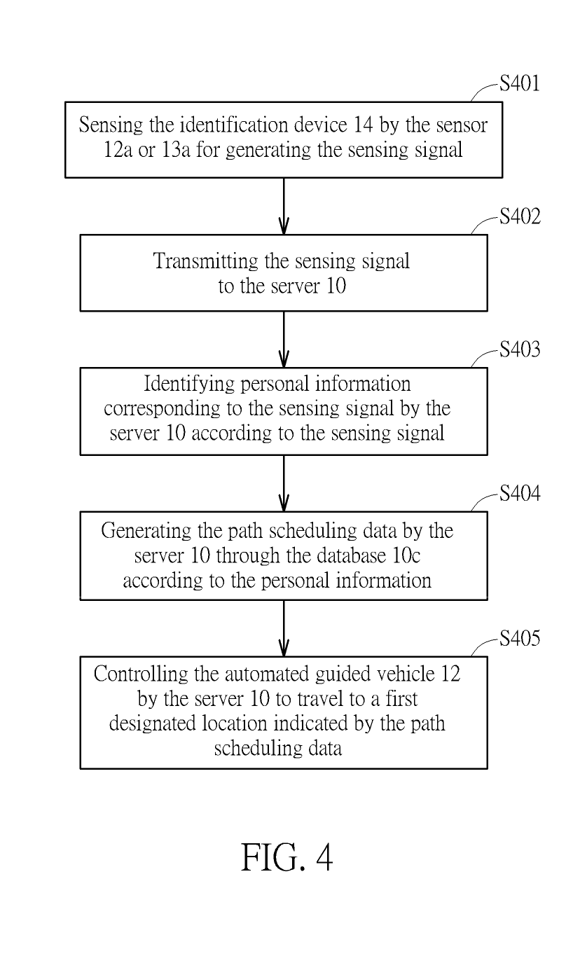

FIG. 4 is a flow chart of a transportation method by using the transportation system 100. The transportation method includes step S401 to step S405. Any reasonable technology modification of the transportation method falls into the scope of the present invention.
Step S401 to step S405 are illustrated below.
step S401: sensing the identification device 14 by the sensor 12a or 13a for generating the sensing signal;
step S402: transmitting the sensing signal to the server 10;
step S403: identifying personal information corresponding to the sensing signal by the server 10 according to the sensing signal;
step S404: generating the path scheduling data by the server 10 through the database 10c according to the personal information;
step S405: controlling the automated guided vehicle 12 by the server 10 to travel to a first designated location indicated by the path scheduling data.

Step S401 to step S405 are previously described. Thus, illustrations of step S401 to step S405 are omitted here. In the transportation system 100, since the automated guided vehicle 12 is linked to the server 10, the server 10 can dynamically control the automated guided vehicle 12 to travel along with an optimal path. The server 10 can also generate tag information on the display device 12d of the automated guided vehicle 12 after a travelling process in each location indicated by the path scheduling data is completed so that the passenger can easily understand a progress of the current scheduling procedure. Also, since the server 10 can use the database 10c for generating the path scheduling data, an event of “going to see a doctor” in the hospital becomes a very easy and automatic errand for the user having the identification device 14. As a result, an efficiency of medical consultation process in the hospital can be improved.

To sum up, the present invention illustrates a transportation method and a transportation system. The transportation system and the transportation method can be applied to a medical system, such as a hospital. In the transportation system, a passenger can use an identification device such as a health insurance card for identifying his/her personal information by the server. Since identity information of the passenger is required to use the automated guided vehicle, the transportation system is capable of reducing unnecessary transportation resource consumption. Further, since the server can synchronously acquire status information of the automated guided vehicle. When a plurality of automated guided vehicles are dispatched to provide services of taking passengers to different locations, the server can keep track of statuses of all automated guided vehicles at any time for optimizing overall travelling efficiency of the passengers. Further, the server can generate path scheduling data corresponding to personal information through the database. Therefore, for a user having the identification device, the event of “going to see a doctor” in the hospital becomes a very easy and automatic errand so that the sense of fear for the user unfamiliar with the hospital's traffic path can be reduced. In addition, the transportation system of the present invention can optimize the path scheduling data by preferentially selecting a location that can be quickly visited in order to reduce a lot of waiting time. Further, the transportation system can dynamically adjust, change, or update the path scheduling data according to the doctor's professional medical advice. The transportation system can provide a scheduling insertion function for the passenger. In order to improve travelling efficiency of the transportation system, the timer can be introduced to the automated guided vehicle of the transportation system for limiting an idle time of the automated guided vehicle in order to avoid wasting a lot of transportation resources. Further, the transportation system has a scheduling interruption function to cope with various emergency situations. Thus, the transportation system of the present invention can provide high operation flexibility and transportation efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transportation method for controlling an automated guided vehicle comprising:
sensing an identification device by a sensor for generating a sensing signal;
transmitting the sensing signal to a server;
identifying personal information corresponding to the sensing signal by the server according to the sensing signal;
generating path scheduling data by the server through a database according to the personal information;
receiving status data of a plurality of locations indicated by the path scheduling data after the path scheduling data is generated by the server;
generating a first sequence according to the status data of the plurality of locations; and
controlling the automated guided vehicle by the server to travel to a first designated location indicated by the path scheduling data;
wherein the status data of the plurality of locations comprises instantaneous transportation data of the locations received by the server in real time or statistic transportation data of the locations stored in the database, and the first designated location has a priority higher than other locations indicated by the path scheduling data.

2. The method of claim 1, wherein the sensor is disposed on the automated guided vehicle or a sensing station.

3. The method of claim 1, further comprising:
receiving a command signal generated from a station by the server;
generating a control signal by the server according to the command signal; and
the automated guided vehicle traveling to a location corresponding to the command signal according to the control signal.

4. The method of claim 1, further comprising:
enabling a timer after the automated guided vehicle reaches the first designated location; and
changing a status of the automated guided vehicle from an occupied mode to an available mode when an activated time of the timer reaches a predetermined idle time;
wherein the timer is activated as long as the automated guided vehicle is parked at the first designated location.

5. The method of claim 1, further comprising:
setting a waiting time after the automated guided vehicle reaches the first designated location;
wherein the automated guided vehicle is operated under an occupied mode during the waiting time.

6. The method of claim 1, further comprising:
receiving an insertion signal by the server, wherein the insertion signal indicates at least one inserted location;
receiving status data of a plurality of locations indicated by the path scheduling data and the insertion signal;
generating a second sequence according to the status data of the plurality of locations;
updating the path scheduling data by the server in order to generate updated path scheduling data; and
controlling the automated guided vehicle by the server to travel to a second designated location indicated by the updated path scheduling data;
wherein the status data of the plurality of locations comprises instantaneous transportation data of the locations received by the server in real time or statistic transportation data of the locations stored in the database, the updated path scheduling data indicates the plurality of locations of the path scheduling data and the insertion signal, and the second designated location has a priority higher than other locations indicated by the updated path scheduling data.

7. The method of claim 1, further comprising:
receiving an interruption signal when the automated guided vehicle is on its way to the first designated location; and
changing a status of the automated guided vehicle from an occupied mode to an available mode when the interruption signal is received.

8. The method of claim 1, wherein controlling the automated guided vehicle by the server to travel to the first designated location indicated by the path scheduling data is controlling the automated guided vehicle by the server to travel to a passenger's location or take the passenger to a scheduled location.

9. A transportation system comprising:
an automated guided vehicle configured to provide a transportation service of taking a passenger;
a server linked to the automated guided vehicle and configured to control the automated guided vehicle; and
a sensor linked to the server and configured to sense an identification device for verifying personal information of the passenger;
wherein the sensor generates a sensing signal by sensing the identification device and transmits the sensing signal to the server, the server identifies the personal information according to the sensing signal, generates path scheduling data through a database of the server according the personal information, and controls the automated guided vehicle to travel to a first designated location indicated by the path scheduling data; and
wherein the server receives status data of a plurality of locations indicated by the path scheduling data after the path scheduling data is generated by the server, the server generates a first sequence according to the status data of the plurality of locations, the status data of the plurality of locations comprises instantaneous transportation data of the locations received by the server in real time or statistic transportation data of the locations stored in a database, and the first designated location has a priority higher than other locations indicated by the path scheduling data.

10. The system of claim 9, further comprising:
a sensing station disposed around the passenger, wherein the sensor is disposed on the sensing station.

11. The system of claim 9, wherein the sensor is disposed on the automated guided vehicle.

12. The system of claim 11, wherein the automated guided vehicle comprises:
a transceiver configured to receive a control signal generated by the server and transmit the sensing signal to the server;
a processor coupled to the sensor and the transceiver and configured to control a travelling route of the automated guided vehicle according to the control signal; and
an anti-collision system coupled to the processor for avoiding an obstacle around the automated guided vehicle.

13. The system of claim 9, further comprising:
a station linked to the server and configured to generate a command signal;
wherein the server generates a control signal according to the command signal, and the automated guided vehicle travels to a location of the command signal according to the control signal.

14. The system of claim 9, wherein a timer function of the automated guided vehicle is executed after the automated guided vehicle reaches the first designated location, and a status of the automated guided vehicle is changed from an occupied mode to an available mode when an activated time of the timer function reaches to a predetermined idle time and the timer is activated as long as the automated guided vehicle is parked at the first designated location.

15. The system of claim 9, wherein a waiting time is set after the automated guided vehicle reaches the first designated location, and the automated guided vehicle is operated under an occupied mode during the waiting time.

16. The system of claim 9, wherein the server receives an insertion signal, the insertion signal indicates at least one inserted location, the server receives status data of a plurality of locations indicated by the path scheduling data and the insertion signal, the server generates a second sequence according to the status data of the plurality of locations, updates the path scheduling data in order to generate updated path scheduling data, controls the automated guided vehicle to travel to a second designated location indicated by the updated path scheduling data, the status data of the plurality of locations comprises instantaneous transportation data of the locations received by the server in real time or statistic transportation data of the locations stored in the database, the updated path scheduling data indicates the plurality of locations of the path scheduling data and the insertion signal, and the second designated location has a priority higher than other locations indicated by the updated path scheduling data.

17. The system of claim 9, wherein the automated guided vehicle receives an interruption signal on its way to the first designated location, and the automated guided vehicle changes a status from an occupied mode to an available mode when the interruption signal is received.

18. The system of claim 9, wherein the automated guided vehicle is controlled to travel to a passenger's location or take the passenger to go to a scheduled location.

19. A transportation system comprising:
an automated guided vehicle configured to provide a transportation service of taking a passenger;
a server linked to the automated guided vehicle and configured to control the automated guided vehicle; and
a sensor linked to the server and configured to sense an identification device for verifying personal information of the passenger;
wherein the sensor generates a sensing signal by sensing the identification device and transmits the sensing signal to the server, the server identifies the personal information according to the sensing signal, generates path scheduling data through a database of the server according the personal information, and controls the automated guided vehicle to travel to a first designated location indicated by the path scheduling data; and
wherein when the server receives an insertion signal and the insertion signal indicates at least one inserted location, the server receives status data of a plurality of locations indicated by the path scheduling data and the insertion signal, the server generates a second sequence according to the status data of the plurality of locations, updates the path scheduling data in order to generate updated path scheduling data, controls the automated guided vehicle to travel to a second designated location indicated by the updated path scheduling data, the status data of the plurality of locations comprises instantaneous transportation data of the locations received by the server in real time or statistic transportation data of the locations stored in the database, the updated path scheduling data indicates the plurality of locations of the path scheduling data and the insertion signal, and the second designated location has a priority higher than other locations indicated by the updated path scheduling data.
